(19) United States
(12) Patent Application Publication
(10) Pub. No.: US 2009/0053557 A1
(43) Pub. Date: Feb. 26, 2009

(54) STABILIZED WHITE-EMITTING OLED DEVICE

(76) Inventors: Jeffrey P. Spindler, Rochester, NY (US); Tukaram K. Hatwar, Penfield, NY (US)

Correspondence Address: Frank Pincelli;Patent Legal Staff, Eastman Kodak Company, 343 State Street, Rochester, NY, 14650-2201, US

(21) Appl. No.: 11/843,835

(22) Filed: Aug. 23, 2007

(51) Int. Cl. B32B 9/00

(52) U.S. Cl. 428/690

(57) ABSTRACT

White light-emitting OLED device having an anode and a cathode, comprising: a first light-emitting layer provided over the anode and containing a first host material and a first light-emitting material, wherein the first host material is a mixture of one or more mono-anthracene derivatives and one or more aromatic amine derivatives, wherein the mono-anthracene derivative(s) being provided in a volume fraction range of greater than 50% and less than or equal to 95% relative to the total layer volume, and the aromatic amine derivative(s) being provided in a volume fraction range of 1% to 40% relative to the total layer volume, and wherein the first light-emitting material has a peak emission in the yellow to red portion of the spectrum; a second light-emitting layer provided over or under the first light-emitting layer, wherein the second light-emitting layer has a peak emission in the blue to cyan portion of the spectrum.

### CROSS REFERENCE TO RELATED APPLICATIONS

Reference is made to commonly assigned U.S. patent application Ser. No. 11/393,316, filed Mar. 30, 2006, by Hatwar et al. the disclosures of which are incorporated herein by reference.

### FIELD OF THE INVENTION

The present invention relates to providing a white-light-emitting organic electroluminescent device having improved lifetime.

### BACKGROUND OF THE INVENTION

An organic light-emitting diode device, also called an OLED device, commonly includes a substrate, an anode, a hole-transporting layer made of an organic compound, an organic luminescent layer with suitable dopants, an organic electron-transporting layer, and a cathode. OLED devices are attractive because of their low driving voltage, high luminance, wide-angle viewing and capability for full-color flat emission displays. Tang et al. described this multilayer OLED device in their U.S. Pat. Nos. 4,769,292 and 4,885,211.

OLEDs can emit different colors, such as red, green, blue, or white, depending on the emitting property of its LEL. Recently, there is an increasing demand for broadband OLEDs to be incorporated into various applications, such as a solid-state lighting source, color display, or a full color display. By broadband emission, it is meant that an OLED emits sufficiently broad light throughout the visible spectrum so that such light can be used in conjunction with filters or color change modules to produce displays with at least two different colors or a full color display. In particular, there is a need for white light-emitting OLEDs where there is substantial emission in the red, green, and blue portions of the spectrum, wherein a white-emitting electroluminescent (EL) layer can be used to form a multicolor device. Each pixel is coupled with a color filter element as part of a color filter array (CFA) to achieve a pixilated multicolor display. The organic EL layer is common to all pixels and the final color as perceived by the viewer is dictated by that pixel's corresponding color filter element. Therefore, a multicolor or RGB device can be produced without requiring any patterning of the organic EL layers. An example of a white CFA top-emitting device is shown in U.S. Pat. No. 6,392,340.

In order to achieve broadband emission from an OLED, more than one type of molecule has to be excited, because each type of molecule only emits light with a relatively narrow spectrum under normal conditions. A light-emitting layer having a host material and one or more luminescent dopant(s) can achieve light emission from both the host and the dopant(s) resulting in a broadband emission in the visible spectrum if the energy transfer from the host material to the dopant(s) is incomplete. However, to achieve a broadband OLED having a single light-emitting layer, the concentrations of light-emitting dopants must be carefully controlled, which produces manufacturing difficulties. A broadband OLED having two or more light-emitting layers can have better color and better luminance efficiency than a device with one light-emitting layer, and the variability tolerance for dopant concentration is higher. It has also been found that broadband OLEDs having two light-emitting layers are typically more stable than OLEDs having a single light-emitting layer.

White light producing OLED devices have been reported by J. Shi (U.S. Pat. No. 5,683,823) wherein the luminescent layer includes red and blue light-emitting materials uniformly dispersed in a host-emitting material. Sato et al. in JP 07-142169 discloses an OLED device, capable of emitting white light, made by forming a blue light-emitting layer next to the hole-transporting layer and followed by a green light-emitting layer having a region containing a red fluorescent layer. Kido et al., in Science, 267, 1332 (1995) and in Applied Physics Letters, 64, 815 (1994), report a white light-producing OLED device. In this device, three emitter layers with different carrier transport properties, each emitting blue, green, or red light, are used to generate white light. Littman et al. in U.S. Pat. No. 5,405,709 disclose another white emitting device, which is capable of emitting white light in response to hole-electron recombination, and comprises a fluorescent in a visible light range from bluish green to red. More recently, Deshpande et al., in Applied Physics Letters, 75, 888 (1999), published a white OLED device using red, blue, and green luminescent layers separated by a hole-blocking layer.

Kobori et al., in Unexamined Patent Application JP 2001-52870, teach the use of a host comprising a mixture of an anthracene derivative and an aromatic amine for a blue-light-emitting layer, and—if present—other light-emitting layers. They disclose a white light-emitting OLED having two light-emitting layers constructed in this manner. In the examples disclosed, both light-emitting layers include a mixture of an aromatic amine and a bisanthracene compound in a 25%/75% ratio as a host. The first light-emitting layer (which is closer to the anode) includes a rubrene derivative as a yellow light-emitting material doped into the host in a few percent. To make white, a second light-emitting layer (closer to the cathode) is provided on the first light-emitting layer. The second light-emitting layer uses an arylamine-substituted styrene derivative as the blue light-emitting compound doped into the host. In the example, an electron-transporting layer is provided over the second light-emitting layer, an alkali metal halide electron-injecting layer (CsI) disposed over the electron-transporting layer, and a Mg:Ag alloy cathode deposited over the CsI.

Although the OLED disclosed in JP 2001-52870 provides an adequate white color with good lifetime, it is not a robust formulation. For example, merely removing the alkali metal halide electron-injecting layer results in a dramatic shift to yellow emission, with 90% or more of the emission coming from the first light-emitting layer. This also resulted in a significant decrease in efficiency and lifetime. Further, it was indicated that the decrease in lifetime was especially large for the blue. It is known in the art that an Mg:Ag cathode provides good performance without an alkali metal halide layer. Such a dramatic shift in performance based solely on the presence or absence of an alkali metal halide layer is unacceptable from a manufacturing perspective. This indicates that the color, efficiency, and lifetime of this structure are very sensitive. In manufacturing, an OLED formulation must be robust to variables that can arise in the manufacturing process. Some of these variables relate to manufacturing tolerances and can include chemical composition variations, thickness variations, variations in electron- and hole-injecting properties, and so forth. Some other variables relate to degrees of freedom in selection of processes and materials, including the cathode. For various reasons (reflectivity, conductivity, ease of manufacture), one may wish to change the cathode, but without reformulating the device.

Despite these advances, there remains a need to provide white light-emitting OLED devices with greater useful lifetimes.

### SUMMARY OF THE INVENTION

An object of the present invention is to provide an improved OLED structure that enhances stability.

This object is achieved by a white light-emitting OLED device having an anode and a cathode, comprising:

a. a first light-emitting layer provided over the anode and containing a first host material and a first light-emitting material, wherein the first host material is a mixture of one or more mono-anthracene derivatives and one or more aromatic amine derivatives, wherein the mono-anthracene derivative(s) being provided in a volume fraction range of greater than 50% and less than or equal to 95% relative to the total layer volume, and the aromatic amine derivative(s) being provided in a volume fraction range of 1% to 40% relative to the total layer volume, and wherein the first light-emitting material has a peak emission in the yellow to red portion of the spectrum;

b. a second light-emitting layer provided over or under the first light-emitting layer, wherein the second light-emitting layer has a peak emission in the blue to cyan portion of the spectrum; and

c. wherein the peak emissions of the first and second light-emitting layers are selected such that together white light is produced by the OLED device.

This object is also achieved by a white light-emitting OLED device having an anode and a cathode, comprising:

a. a first light-emitting layer provided over the anode and containing a first host material and a first light-emitting material, wherein the first host material is a mixture of one or more mono-anthracene derivatives and one or more aromatic amine derivatives, wherein the mono-anthracene derivative(s) being provided in a volume fraction range of greater than 50% and less than or equal to 95% relative to the total layer volume, and the aromatic amine derivative(s) being provided in a volume fraction range of 1% to 40% relative to the total layer volume, and wherein the first light-emitting material has a peak emission in the green to red portion of the spectrum;

b. a second light-emitting layer provided over or under the first light-emitting layer, wherein the second light-emitting layer has a peak emission in the blue to cyan portion of the spectrum;

c. a third light-emitting layer provided closer to the anode than the first and second light-emitting layers; and

d. wherein the peak emissions of the first, second, and third light-emitting layers are selected such that together white light is produced by the OLED device.

### ADVANTAGES

It is an advantage of this invention that it provides an OLED device with improved luminance lifetime while maintaining good voltage requirements and quantum efficiency.

### BRIEF DESCRIPTION OF THE DRAWINGS

FIG. 1 shows a cross-sectional view of one embodiment of a white light-emitting OLED device in accordance with this invention;

FIG. 2 shows a cross-sectional view of another embodiment of a white light-emitting OLED device in accordance with this invention;

FIG. 3 shows a cross-sectional view of another embodiment of a white light-emitting OLED device in accordance with this invention;

FIG. 4 shows a cross-sectional view of another embodiment of a white light-emitting OLED device in accordance with this invention;

FIG. 5 shows the results of voltage, quantum efficiency, and lifetime measurements for one series of OLED devices; and

FIG. 6 shows the results of voltage, quantum efficiency, and lifetime measurements for another series of OLED devices.

### DETAILED DESCRIPTION OF THE INVENTION

The term “OLED device” is used in its art-recognized meaning of a display device comprising organic light-emitting diodes as pixels. It can mean a device having a single pixel. An OLED display is an OLED device comprising a plurality of pixels, which can be of different colors. The term “pixel” is employed in its art-recognized usage to designate an area of a display panel that is stimulated to emit light independently of other areas. It is recognized that in full color systems, several pixels of different colors will be used together to produce a wide range of colors, and a viewer can term such a group a single pixel. For the purposes of this discussion, such a group will be considered several different colored pixels. A full color system is one capable of emitting in the red, green, and blue regions of the visible spectrum and displaying images in any combination of hues. Hue refers to the intensity profile of light emission within the visible spectrum, with different hues exhibiting visually discernible differences in color. The red, green, and blue colors constitute the three primary colors from which all other colors can be generated by appropriate mixing. In accordance with this disclosure, broadband emission is light that has significant components in multiple portions of the visible spectrum, for example, red and green. Broadband emission can also include the situation where light is emitted in the red, green, and blue portions of the spectrum in order to produce white light. White light is that light that is perceived by a user as having a white color, or light that has an emission spectrum sufficient to be used in combination with color filters to produce a practical full color display. Thus, the term “white light-emitting OLED device” means a device that produces white light internally, even if devices such as color filters prevent some hues from reaching a viewer.

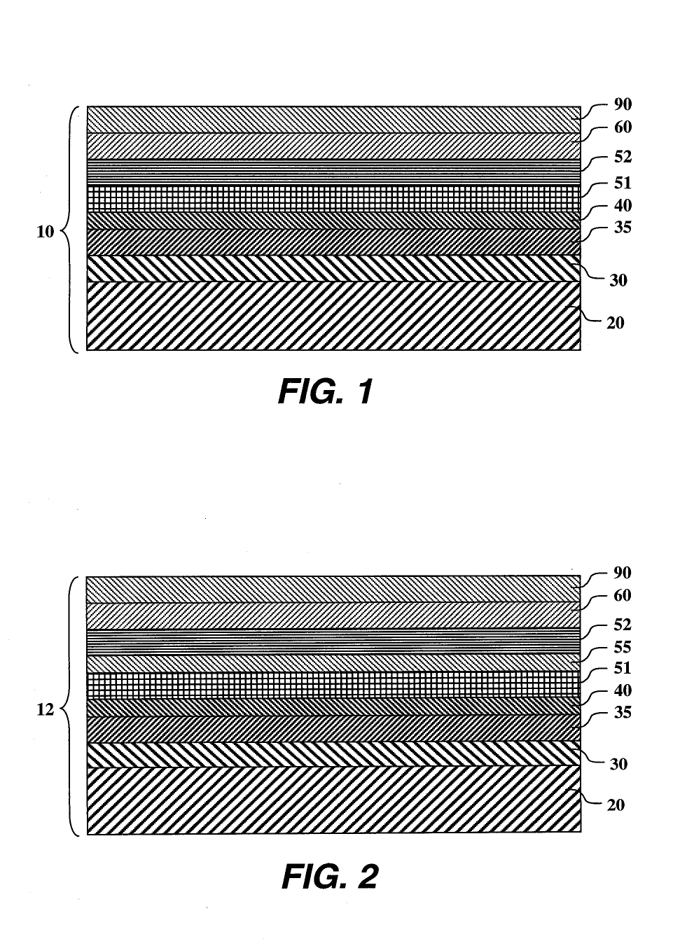

Turning now to FIG. 1, there is shown a cross-sectional view of a pixel of a white light-emitting OLED device 10 according to one embodiment of the present invention. OLED device 10 includes a substrate 20, two spaced electrodes, which are anode 30 and cathode 90, and two light-emitting layers, a first light-emitting layer 51 provided over anode 30, and a second light-emitting layer 52 provided over or under first light-emitting layer 51. First light-emitting layer 51 has a peak emission in the yellow to red portion of the visible spectrum. Second light-emitting layer 52 has a peak emission in the blue to cyan portion of the visible spectrum. The peak emissions of first and second light-emitting layers 51 and 52, respectively, are selected such that together white light is produced by OLED device 10. For example, first light-emitting layer 51 can emit yellow light, and second light-emitting layer 52 can emit blue light. In another example, first light-emitting layer 51 can emit red light, and second light-emitting layer 52 can emit cyan light.

Light-emitting layers such as those described herein produce light in response to hole-electron recombination. Any suitable process such as evaporation, sputtering, chemical vapor deposition, electrochemical deposition, or radiation thermal transfer from a donor material can deposit desired organic light-emitting materials. The light-emitting layers in this invention in general comprise one or more host materials doped with one or more light-emitting guest compounds or dopants where light emission comes primarily from the dopant and will be described in greater detail below. A dopant is selected to produce color light having a particular spectrum and to have other desirable properties. Dopants are typically coated as 0.01 to 15% by weight into the host material.

First light-emitting layer 51 contains a first host material and a first light-emitting material. The first host material is a mixture of one or more mono-anthracene derivatives and one or more aromatic amine derivatives. The mono-anthracene derivative(s) are provided in a volume fraction range of greater than 50% and less than or equal to 95% relative to the total layer volume. The aromatic amine derivative(s) are provided in a volume fraction range of 1% to 40% relative to the total layer volume. The mono-anthracene derivative is desirably a 9,10-diarylanthracene, certain derivatives of which (Formula A) are known to constitute a class of useful host materials capable of supporting electroluminescence, and are particularly suitable for light emission of wavelengths longer than 400 nm, e.g., blue, green, yellow, orange or red

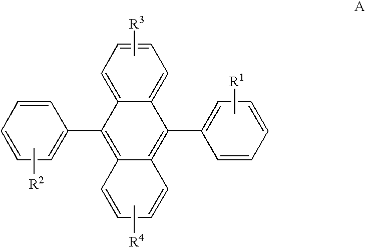

wherein R¹, R², R³, and R⁴ represent one or more substituents on each ring where each substituent is individually selected from the following groups:

Group 1: hydrogen, or alkyl of from 1 to 24 carbon atoms;

Group 2: aryl or substituted aryl of from 5 to 20 carbon atoms;

Group 3: carbon atoms from 4 to 24 necessary to complete a fused aromatic ring of naphthyl, pyrenyl, or perylenyl;

Group 4: heteroaryl or substituted heteroaryl of from 5 to 24 carbon atoms as necessary to complete a fused heteroaromatic ring of furyl, thienyl, pyridyl, quinolinyl or other heterocyclic systems;

Group 5: alkoxylamino, alkylamino, or arylamino of from 1 to 24 carbon atoms; and

Group 6: fluorine, chlorine, bromine or cyano.

Particularly useful are compounds wherein R¹ and R², and in some cases R³, represent additional aromatic rings, e.g. Group 3. Specific examples of useful anthracene materials for use as a host in a light-emitting layer include:

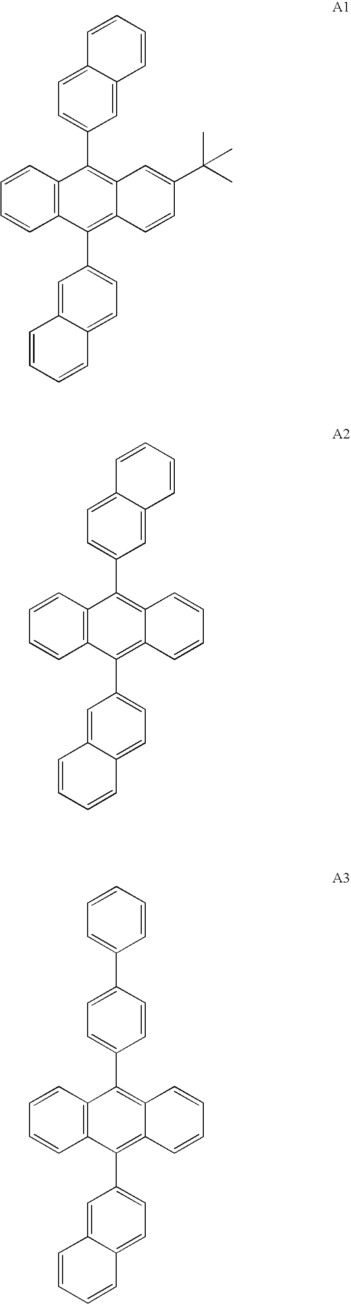

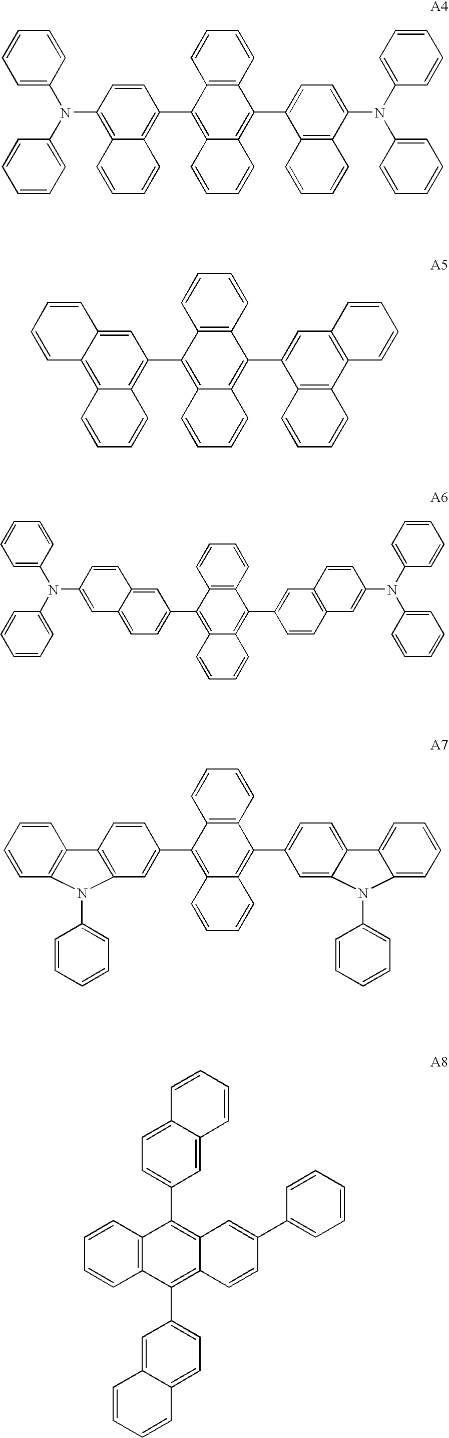

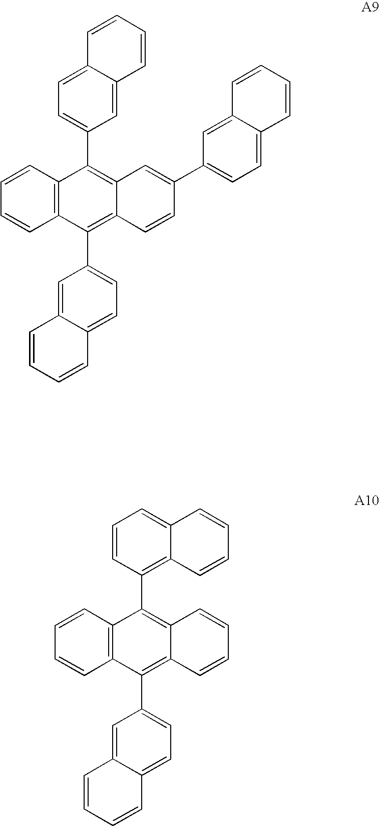

Particularly useful in this invention is 9-(1-naphthyl)-10-(2-naphthyl)anthracene, e.g. structure A10.

The aromatic amine host material includes a hole-transporting material. Hole-transporting materials useful as hosts in light-emitting layers are well known to include compounds such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Klupfel et al. in U.S. Pat. No. 3,180,730 illustrate exemplary monomeric triarylamines. In U.S. Pat. Nos. 3,567,450 and 3,658,520, by Brantley et al., other suitable triarylamines substituted with one or more vinyl radicals or comprising at least one active hydrogen-containing group are disclosed.

A more preferred class of aromatic tertiary amines are those which include at least two aromatic tertiary amine moieties as described in U.S. Pat. Nos. 4,720,432 and 5,061,569. Such compounds include those represented by structural Formula B.

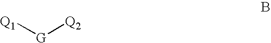

wherein:

Q₁ and Q₂ are independently selected aromatic tertiary amine moieties; and

G is a linking group such as an arylene, cycloalkylene, or alkylene group of a carbon-to-carbon bond.

One class of such aromatic tertiary amines are the tetraaryldiamines. Desirable tetraaryldiamines include two diarylamino groups linked through an arylene group. Useful tetraaryldiamines include those represented by Formula C.

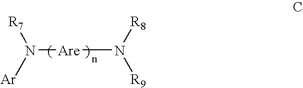

wherein:

each Are is an independently selected arylene group, such as a phenylene or anthracene moiety;

n is an integer of from 1 to 4; and

Ar, R₇, R₈, and R₉ are independently selected aryl groups.

The various alkyl, alkylene, aryl, and arylene moieties of the foregoing structural Formulae B and C can each in turn be substituted. Typical substituents include alkyl groups, alkoxy groups, aryl groups, aryloxy groups, and halogens such as fluoride, chloride, and bromide. The various alkyl and alkylene moieties typically contain from 1 to about 6 carbon atoms. The cycloalkyl moieties can contain from 3 to about 10 carbon atoms, but typically contain five, six, or seven carbon atoms—e.g., cyclopentyl, cyclohexyl, and cycloheptyl ring structures. The aryl and arylene moieties are usually phenyl and phenylene moieties. Usefully, the hole-transporting host material is an N,N,N′,N′-tetraarylbenzidine, wherein the Are of Formula C represents a phenylene group and n equals 2.

In addition to a host material as described above, first light-emitting layer 51 also includes one or more dopants as the first light-emitting material. The first light-emitting material has a peak emission in the yellow to red portion of the visible spectrum, and therefore the dopants that are used have emission in this region. A light-emitting yellow dopant can include a compound of the following structures:

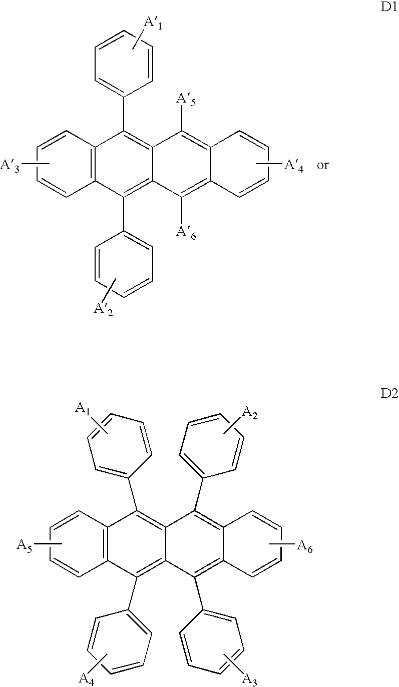

wherein A₁-A₆ and A′₁-A′₆ represent one or more substituents on each ring and where each substituent is individually selected from one of the following:
Category 1: hydrogen, or alkyl of from 1 to 24 carbon atoms;
Category 2: aryl or substituted aryl of from 5 to 20 carbon atoms;
Category 3: hydrocarbon containing 4 to 24 carbon atoms, completing a fused aromatic ring or ring system;
Category 4: heteroaryl or substituted heteroaryl of from 5 to 24 carbon atoms such as thiazolyl, furyl, thienyl, pyridyl, quinolinyl or other heterocyclic systems, which are bonded via a single bond, or complete a fused heteroaromatic ring system;
Category 5: alkoxylamino, alkylamino, or arylamino of from 1 to 24 carbon atoms; or
Category 6: fluoro, chloro, bromo or cyano.

Examples of particularly useful yellow dopants are shown in U.S. Pat. No. 7,252,893 the contents of which are incorporated by reference.

A red-light-emitting dopant can include a diindenoperylene compound of the following structure E:

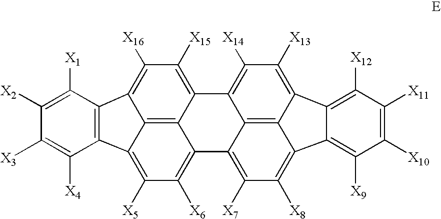

wherein:
X₁-X₁₆ are independently selected as hydrogen or substituents that include alkyl groups of from 1 to 24 carbon atoms; aryl or substituted aryl groups of from 5 to 20 carbon atoms; hydrocarbon groups containing 4 to 24 carbon atoms that complete one or more fused aromatic rings or ring systems; or halogen, provided that the substituents are selected to provide an emission maximum between 560 nm and 640 nm.

Hatwar et al. the contents of which are incorporated by reference show illustrative examples of useful red dopants of this class, U.S. Pat. No. 7,247,394.

Some other red dopants belong to the DCM class of dyes represented by Formula F:

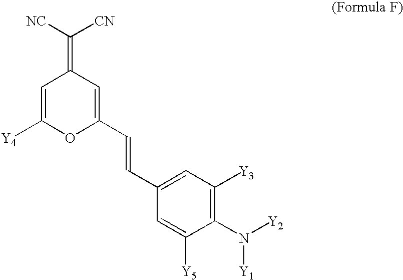

wherein Y₁-Y₅ represent one or more groups independently selected from: hydro, alkyl, substituted alkyl, aryl, or substituted aryl; Y₁-Y₅ independently include acyclic groups or can be joined pairwise to form one or more fused rings; provided that Y₃ and Y₅ do not together form a fused ring. Ricks et al. show structures of particularly useful dopants of the DCM class.

Second light-emitting layer 52 includes a host and a dopant. The host can be an anthracene derivative or a mixture including an anthracene derivative and an aromatic amine. The anthracene derivative can be a compound of Structure A, as described above, except that for second light-emitting layer 52 the host is not limited to mono-anthracenes. Thus, R¹ or R² of Structure A can include carbon atoms necessary to complete a fused aromatic ring of anthracene. If the anthracene derivative is a mono-anthracene, it can be the same as or different from that used in first light-emitting layer 51. The anthracene host can be present in the concentration range of from 75% to 99% by volume. The aromatic amine co-host, if used, can be as described above and can be present in the concentration range of from 1% to 20% by volume. The dopant can be present in the concentration range of from 1% to 10% by volume. A blue-light-emitting dopant can include a bis(azinyl)azene boron complex compound of the structure

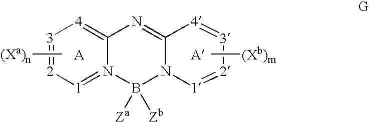

wherein:
A and A′ represent independent azine ring systems corresponding to 6-membered aromatic ring systems containing at least one nitrogen;
(X^{a})ₙ and (X^{b})ₘ represent one or more independently selected substituents and include acyclic substituents or are joined to form a ring fused to A or A′;
m and n are independently 0 to 4;
Z^{a} and Z^{b} are independently selected substituents;
1, 2, 3, 4, 1′, 2′, 3′, and 4′ are independently selected as either carbon or nitrogen atoms; and
provided that X^{a}, X^{b}, Z^{a}, and Z^{b}, 1, 2, 3, 4, 1′, 2′, 3′, and 4′ are selected to provide blue luminescence.

Ricks et al disclose some examples of the above class of dopants. The concentration of this class of dopants in second light-emitting layer 52 is desirably between 0.1% and 5%.

Another class of blue dopants is the perylene class. Particularly useful blue dopants of the perylene class include perylene and tetra-t-butylperylene (TBP).

Another class of blue dopants includes blue-emitting derivatives of such styrylarenes and distyrylarenes as distyrylbenzene, styrylbiphenyl, and distyrylbiphenyl, including compounds described in U.S. Pat. No. 5,121,029, and US Publication No. 2006/0093856) by Helber et al. _Among such derivatives that provide blue luminescence, particularly useful in second light-emitting layer 52 are those substituted with diarylamino groups and herein termed aminostyrylarene dopants. Examples include bis[2-[4-[N,N-diarylamino]phenyl]vinyl]-benzenes of the general structure H1 shown below:

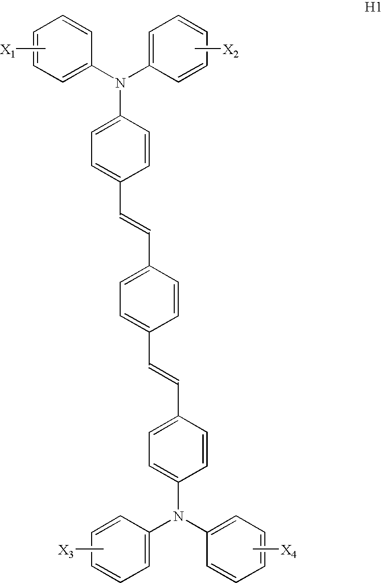

[N,N-diarylamino][2-[4-[N,N-diarylamino]phenyl]vinyl]biphenyls of the general structure H2 shown below:

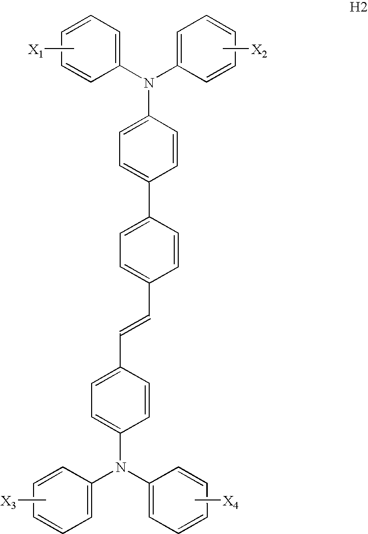

and bis[2-[4-[N,N-diarylamino]phenyl]vinyl]biphenyls of the general structure H3 shown below:

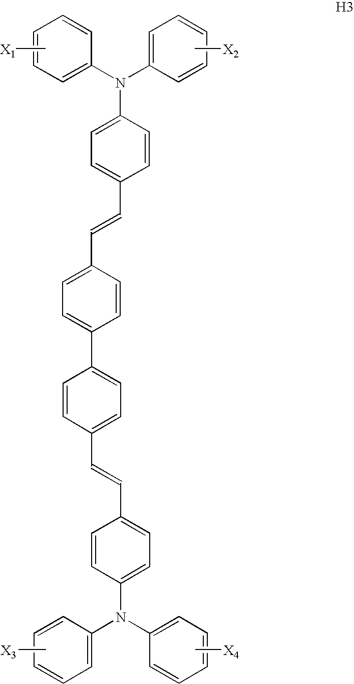

In Formulas H1 to H3, X₁-X₄ can be the same or different, and individually represent one or more substituents such as alkyl, aryl, fused aryl, halo, or cyano. In a preferred embodiment, X₁-X₄ are individually alkyl groups, each containing from one to about ten carbon atoms. Ricks et al disclose a particularly preferred blue dopant of this class. When this class of blue dopants is used, it is desirable that the host material of second light-emitting layer 52 be an anthracene host and not contains an aromatic amine derivative. A useful concentration range for these dopants in second light-emitting layer 52 is between 0.5% and 10%. Usefully, first and second light-emitting layers 51 and 52 are arranged such that first light-emitting layer 51 is closer to anode 30 than second light-emitting layer 52.

Other OLED device layers that can be used in this invention have been well described in the art, and OLED device 10, and other such devices described herein, can include layers commonly used for such devices. OLED devices are commonly formed on a substrate, e.g. OLED substrate 20. Such substrates have been well-described in the art. A bottom electrode is formed over OLED substrate 20 and is most commonly configured as an anode 30, although the practice of this invention is not limited to this configuration. When EL emission is viewed through the anode, the anode should be transparent, or substantially transparent, to the emission of interest. Common transparent anode materials used in the present invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides such as gallium nitride, and metal selenides such as zinc selenide, and metal sulfides such as zinc sulfide, can be used as the anode. For applications where EL emission is viewed only through the cathode electrode, the transmissive characteristics of the anode are immaterial and many conductive materials can be used, regardless if transparent, opaque, or reflective. Example conductors for the present invention include, but are not limited to, gold, iridium, molybdenum, palladium, and platinum. Typical anode materials, transmissive or otherwise, have a work function no less than 4.0 eV. Any suitable process such as evaporation, sputtering, chemical vapor deposition, or electrochemical deposition can deposit desired anode materials. Anode materials can be patterned using well-known photolithographic processes.

Hole-transporting layer 40 can be formed and disposed over the anode. Hole-transporting layer 40 can comprise any hole-transporting material useful in OLED devices. Many examples of these are known in the art. Any suitable process such as evaporation, sputtering, chemical vapor deposition, electrochemical deposition, thermal transfer, or laser thermal transfer from a donor material can deposit desired hole-transporting materials. Hole-transporting materials useful in hole-transporting layers include hole-transporting compounds described above as light-emitting hosts.

Electron-transporting layer 60 can comprise any electron-transporting material useful in OLED devices. Many examples of these are known in the art. Electron-transporting layer 60 can contain one or more metal chelated oxinoid compounds, including chelates of oxine itself, also commonly referred to as 8-quinolinol or 8-hydroxyquinoline. Other electron-transporting materials include various butadiene derivatives as disclosed in U.S. Pat. No. 4,356,429 and various heterocyclic optical brighteners as described in U.S. Pat. No. 4,539,507. Benzazoles, oxadiazoles, triazoles, pyridinethiadiazoles, triazines, phenanthroline derivatives, and some silole derivatives are also useful electron-transporting materials.

An upper electrode most commonly configured as a cathode 90 is formed over the electron-transporting layer. If the device is top-emitting, the electrode must be transparent or nearly transparent. For such applications, metals must be thin (preferably less than 25 nm) or one must use transparent conductive oxides (e.g. indium-tin oxide, indium-zinc oxide), or a combination of these materials. Optically transparent cathodes have been described in more detail in U.S. Pat. No. 5,776,623. If the device is bottom-emitting, the cathode can be any conductive material known to be useful in OLED devices. Evaporation, sputtering, or chemical vapor deposition can deposit cathode materials. When needed, patterning can be achieved through many well known methods including, but not limited to, through-mask deposition, integral shadow masking as described in U.S. Pat. No. 5,276,380 and EP 0 732 868, laser ablation, and selective chemical vapor deposition.

OLED device 10 can include other layers as well. For example, a hole-injecting layer 35 can be formed over the anode, as described in U.S. Pat. No. 4,720,432, U.S. Pat. No. 6,208,075, EP 0 891 121 A1, and EP 1 029 909 A1. An electron-injecting layer, such as alkaline or alkaline earth metals, alkali halide salts, or alkaline or alkaline earth metal doped organic layers, can also be present between cathode 90 and electron-transporting layer 60.

Turning now to FIG. 2, there is shown a cross-sectional view of a pixel of a white light-emitting OLED device in accordance with another embodiment this invention. OLED device 12 is similar to OLED device 10 described above, but further includes non-emitting spacer layer 55 between first light-emitting layer 51 and second light-emitting layer 52. Spacer layer 55 includes one or more host material(s) and one or more stabilizing material(s). The host material spacer layer 55 is a hole-transporting material and can be a single component, or a mixture of components with the hole-transporting material being the main host component. The stabilizing material in spacer layer 55 can be one or more mono-anthracene derivatives provided in a concentration range of 5% to 50% by volume. The hole-transporting material(s) can be aromatic amine derivatives as described above provided in a volume fraction range of 50% to 95%. Hatwar et al. have described such layers in U.S. patent application Ser. No. 11/393,316.

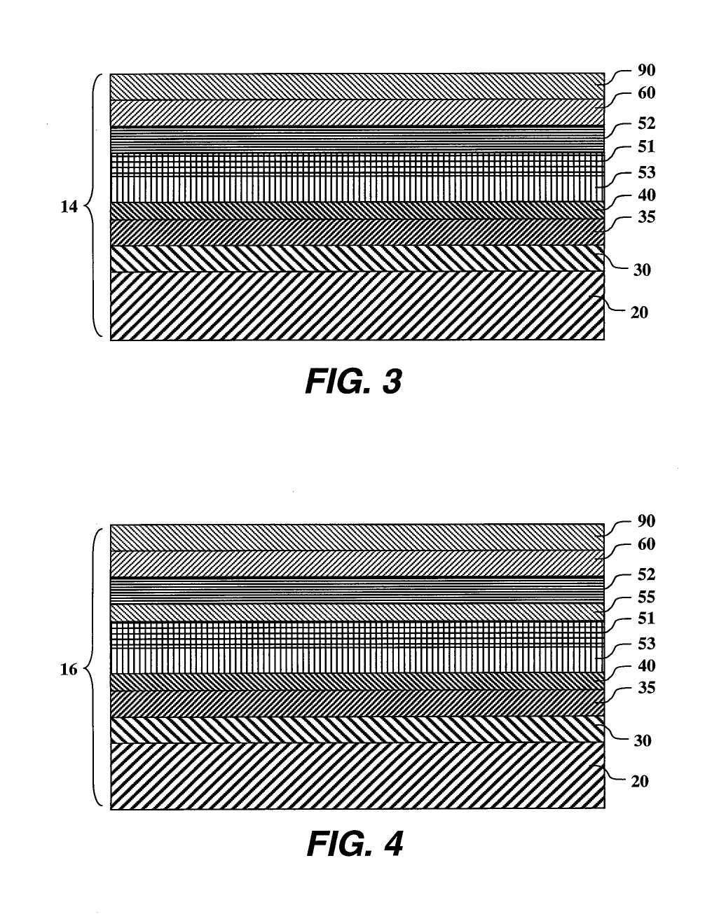

Turning now to FIG. 3, there is shown a cross-sectional view of another embodiment of a white light-emitting OLED device in accordance with this invention. OLED device 14 includes a substrate 20, two spaced electrodes, which are anode 30 and cathode 90, and three light-emitting layers, a first light-emitting layer 51 provided over anode 30, a second light-emitting layer 52 provided over or under first light-emitting layer 51, and a third light-emitting layer closer to anode 30 than first and second light-emitting layers 51 and 52. First light-emitting layer 51 has a peak emission in the green to red portion of the visible spectrum. Second light-emitting layer 52 has a peak emission in the blue to cyan portion of the visible spectrum. Third light-emitting layer 53 has a peak emission in the yellow to red portion of the visible spectrum. The peak emissions of first, second, and third light-emitting layers 51, 52, and 53, respectively, are selected such that together white light is produced by OLED device 14. For example, first light-emitting layer 51 can emit green light, second light-emitting layer 52 can emit blue light, and third light-emitting layer 53 can emit red light. In another example, first light-emitting layer 51 can emit yellow light, second light-emitting layer 52 can emit blue light, and third light-emitting layer 53 can emit red light. In another example, first light-emitting layer 51 can emit green light, second light-emitting layer 52 can emit blue light, and third light-emitting layer 53 can emit yellow light.

First light-emitting layer 51 includes a host material as described above. It also includes one or more dopants as the first light-emitting material, which has a peak emission in the green to red portion of the visible spectrum. Examples of yellow and red light-emitting dopants useful in this layer have been described above. Examples of green light-emitting dopants are well-known, e.g. a quinacridone compound of the following structure:

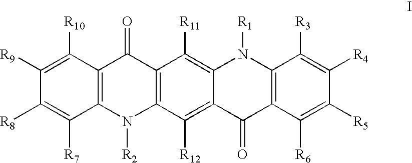

wherein substituent groups R₁ and R₂ are independently alkyl, alkoxyl, aryl, or heteroaryl; and substituent groups R₃ through R₁₂ are independently hydrogen, alkyl, alkoxyl, halogen, aryl, or heteroaryl, and adjacent substituent groups R₃ through R₁₀ can optionally be connected to form one or more ring systems, including fused aromatic and fused heteroaromatic rings, provided that the substituents are selected to provide an emission maximum between 510 nm and 540 nm. Alkyl, alkoxyl, aryl, heteroaryl, fused aromatic ring and fused heteroaromatic ring substituent groups can be further substituted. Some examples of useful quinacridones include those disclosed in U.S. Pat. No. 5,593,788 and in US2004/0001969A1. Examples of useful quinacridone green dopants include:

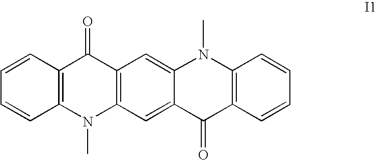

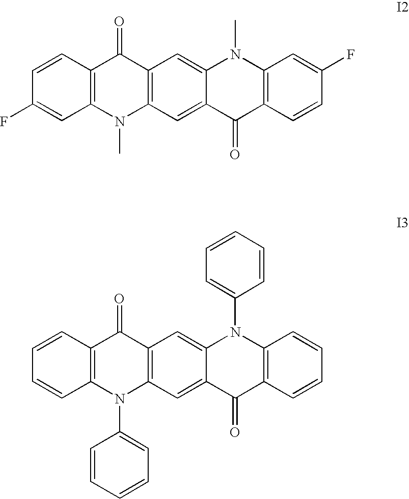

Turning now to FIG. 4, there is shown a cross-sectional view of another embodiment of a white light-emitting OLED device in accordance with this invention. OLED device 16 is similar to OLED device 14 described above, but further includes non-emitting spacer layer 55, as described above, between first light-emitting layer 51 and second light-emitting layer 52.

The invention and its advantages can be better appreciated by the following comparative examples. Examples 4 and 5 are representative examples of one embodiment of this invention, while Examples 1 to 3 are non-inventive OLED device examples shown for comparison and trend purposes. Examples 9 and 10 are representative examples of another embodiment of this invention, while Examples 6 to 8 are non-inventive OLED device examples shown for comparison and trend purposes. The layers described as vacuum-deposited were deposited by evaporation from heated boats under a vacuum of approximately 10⁻⁶ Torr. After deposition of the OLED layers each device was then transferred to a dry box for encapsulation. The OLED has an emission area of 10 mm². Applying a current of 20 mA/cm2 across electrodes tested the devices, except that the fade stability was tested at 80 mA/cm². The results from Examples 1 to 10 are given in Table 1.

### EXAMPLE 1

### Comparative

1. A clean glass substrate was deposited by sputtering with indium tin oxide (ITO) to form a transparent electrode of 60 nm thickness.
2. The above-prepared ITO surface was treated with a plasma oxygen etch.
3. The above-prepared substrate was further treated by vacuum-depositing a 10 nm layer of hexacyanohexaazatriphenylene (CHATP) as a hole-injecting layer (HIL).

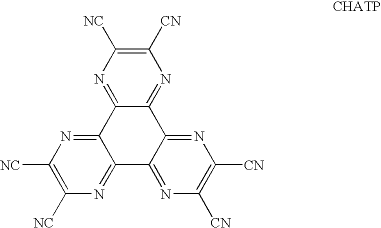

4. The above-prepared substrate was further treated by vacuum-depositing a 120 nm layer of 4,4′-bis[N-(1-naphthyl)-N-phenylamino]biphenyl (NPB) as a hole-transporting layer (HTL).
5. The above-prepared substrate was further treated by vacuum-depositing a 40 nm yellow light-emitting layer of NPB (as host) with 2% yellow-orange emitting dopant diphenyltetra-t-butylrubrene (PTBR).

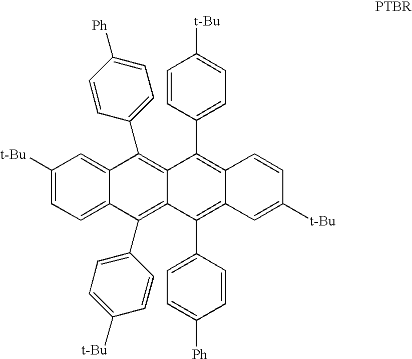

6. The above-prepared substrate was further treated by vacuum-depositing a 30 nm blue light-emitting layer including 28 nm 9-(1-naphthyl)-10-(2-naphthyl)anthracene
(NNA) host and 2 nm NPB co-host with 1% BEP as blue-emitting dopant.

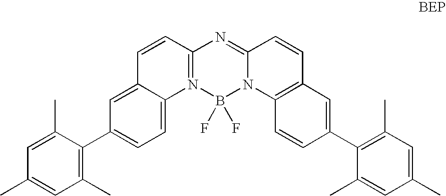

7. A 30 nm mixed electron-transporting layer was vacuum-deposited, including 15 nm 4,7-diphenyl-1,10-phenanthroline (also known as bathophen or Bphen), 15 nm tris(8-quinolinolato)aluminum (III) (ALQ) as co-host, with 2% Li metal.
8. A 100 nm layer of aluminum was evaporatively deposited onto the substrate to form a cathode layer.

### EXAMPLE 2

### Comparative

An OLED device was constructed as described above for Example 1 except that Step 5 was as follows:
5. The above-prepared substrate was further treated by vacuum-depositing a 40 nm yellow light-emitting layer including 30 nm NPB (as host) and 10 nm NNA as a co-host with 2% yellow-orange emitting dopant PTBR.

### EXAMPLE 3

### Comparative

An OLED device was constructed as described above for Example 1 except that Step 5 was as follows:
5. The above-prepared substrate was further treated by vacuum-depositing a 40 nm yellow light-emitting layer including 20 nm NPB (as host) and 20 nm NNA as a co-host with 2% yellow-orange emitting dopant PTBR.

### EXAMPLE 4

### Inventive

An OLED device was constructed as described above for Example 1 except that Step 5 was as follows:
5. The above-prepared substrate was further treated by vacuum-depositing a 40 nm yellow light-emitting layer including 15 nm NPB (as host) and 25 nm NNA as a co-host with 2% yellow-orange emitting dopant PTBR.

### EXAMPLE 5

### Inventive

An OLED device was constructed as described above for Example 1 except that Step 5 was as follows:
5. The above-prepared substrate was further treated by vacuum-depositing a 40 nm yellow light-emitting layer including 10 nm NPB (as host) and 30 nm NNA as a co-host with 2% yellow-orange emitting dopant PTBR.

### EXAMPLE 6

### Comparative

An OLED device was constructed as described above for Example 1 except that Step 6 was as follows:
6. The above-prepared substrate was further treated by vacuum-depositing a 30 nm blue light-emitting layer including 30 nm NNA host with 3% [N,N-di-p-tolylamino][2-[4-[N,N-di-p-tolylamino]phenyl]vinyl]biphenyl as blue-emitting dopant.

### EXAMPLE 7

### Comparative

An OLED device was constructed as described above for Example 6 except that Step 5 was as follows:
5. The above-prepared substrate was further treated by vacuum-depositing a 40 nm yellow light-emitting layer including 30 nm NPB (as host) and 10 nm NNA as a co-host with 2% yellow-orange emitting dopant PTBR.

### EXAMPLE 8

### Comparative

An OLED device was constructed as described above for Example 6 except that Step 5 was as follows:
5. The above-prepared substrate was further treated by vacuum-depositing a 40 nm yellow light-emitting layer including 20 nm NPB (as host) and 20 nm NNA as a co-host with 2% yellow-orange emitting dopant PTBR.

### EXAMPLE 9

### Inventive

An OLED device was constructed as described above for Example 6 except that Step 5 was as follows:
5. The above-prepared substrate was further treated by vacuum-depositing a 40 nm yellow light-emitting layer including 15 nm NPB (as host) and 25 nm NNA as a co-host with 2% yellow-orange emitting dopant PTBR.

### EXAMPLE 10

### Inventive

An OLED device was constructed as described above for Example 6 except that Step 5 was as follows:
5. The above-prepared substrate was further treated by vacuum-depositing a 40 nm yellow light-emitting layer including 10 nm NPB (as host) and 30 nm NNA as a co-host with 2% yellow-orange emitting dopant PTBR.

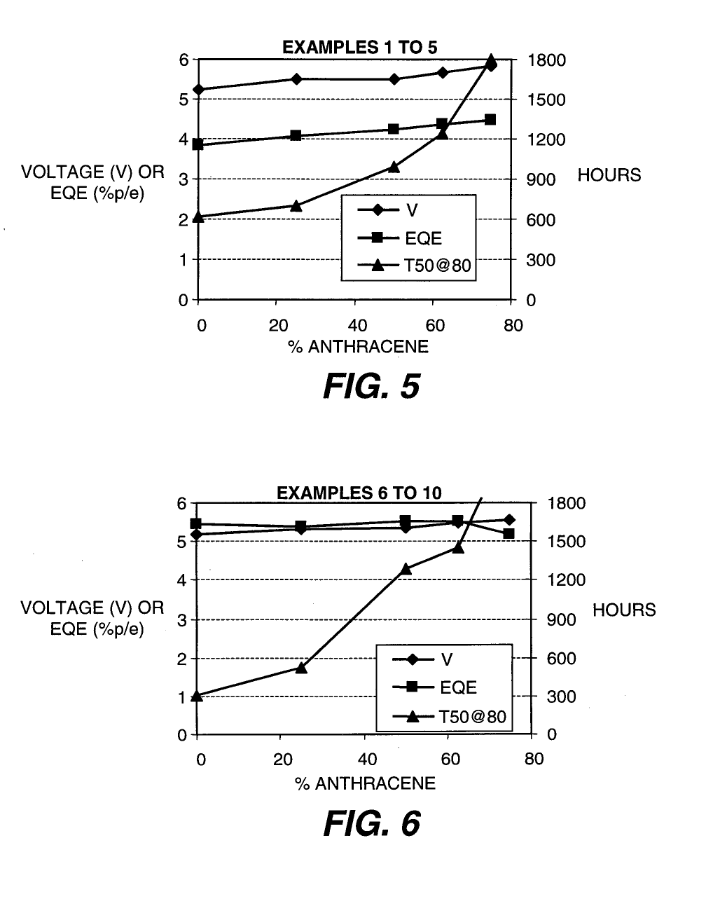

The results of testing these examples are shown in Table 1, below. The inventive examples (4, 5, 9, and 10) show, relative to their respective comparative examples, a trend toward improved fade stability as the percentage of mono-anthracene host increases. This is also shown in FIG. 5, which shows plots of fade stability (triangles), voltage (diamonds), and quantum efficiency (squares) data for Examples 1-5, and FIG. 6, which shows plots of the same data for Examples 6-10. FIG. 5 shows that as the percentage of mono-anthracene are increased, the fade stability increases significantly, while quantum efficiency increases slightly, and the needed voltage only increases slightly. FIG. 6 shows that the fade stability for its examples increases significantly, while quantum efficiency and voltage requirements are almost unchanged. Table 1 also shows that other important properties, such as luminance efficiency, power efficiency, and lumens/watt, do not change very much. Thus, this invention provides an OLED device with improved luminance lifetime while maintaining good voltage requirements and quantum efficiency.

The invention has been described in detail with particular reference to certain preferred embodiments thereof, but it will be understood that variations and modifications can be effected within the spirit and scope of the invention.

TABLE 1
Device data measured at 20 mA/cm² (except fade data)

| | % | | | | | | | | |
|---|---|---|---|---|---|---|---|---|---|
| | Anthracene | | | | | | | | Room Temp |
| | host | | Lum | Power | | | | | Fade Stability |
| | (yellow | | Efficiency | Efficiency | | | | | @ 80 mA/cm² |
| Device # | layer) | Voltage | (cd/A) | (W/A) | CIEx | CIEy | lm/W | QE % | (hrs to 50%) |
| Example 1 | 0 | 5.2 | 6.9 | 0.091 | 0.263 | 0.244 | 4.1 | 3.8 | 623 |
| (Comparative) | | | | | | | | | |
| Example 2 | 25 | 5.5 | 7.7 | 0.095 | 0.278 | 0.262 | 4.4 | 4.1 | 705 |
| (Comparative) | | | | | | | | | |
| Example 3 | 50 | 5.5 | 8.5 | 0.098 | 0.307 | 0.286 | 4.8 | 4.2 | 994 |
| (Comparative) | | | | | | | | | |
| Example 4 | 62.5 | 5.7 | 8.9 | 0.100 | 0.321 | 0.296 | 5.0 | 4.4 | 1240 |
| (Inventive) | | | | | | | | | |
| Example 5 | 75 | 5.8 | 9.4 | 0.100 | 0.350 | 0.315 | 5.0 | 4.5 | 1800 |
| (Inventive) | | | | | | | | | |
| Example 6 | 0 | 5.2 | 10.4 | 0.130 | 0.265 | 0.267 | 6.3 | 5.5 | 310 |
| (Comparative) | | | | | | | | | |
| Example 7 | 25 | 5.3 | 11.3 | 0.125 | 0.297 | 0.309 | 6.7 | 5.4 | 526 |
| (Comparative) | | | | | | | | | |
| Example 8 | 50 | 5.3 | 11.9 | 0.126 | 0.331 | 0.323 | 7.0 | 5.5 | 1283 |
| (Comparative) | | | | | | | | | |
| Example 9 | 62.5 | 5.5 | 12.0 | 0.125 | 0.334 | 0.327 | 6.8 | 5.5 | 1450 |
| (Inventive) | | | | | | | | | |
| Example 10 | 75 | 5.5 | 11.6 | 0.116 | 0.363 | 0.350 | 6.6 | 5.2 | 2300 |
| (Inventive) | | | | | | | | | |

### PARTS LIST

10 OLED device
12 OLED device
14 OLED device
16 OLED device
20 substrate
30 anode
35 hole-injecting layer
40 hole-transporting layer
51 first light-emitting layer
52 second light-emitting layer
53 third light-emitting layer
55 spacer layer
60 electron-transporting layer
90 cathode

1. A white light-emitting OLED device having an anode and a cathode, comprising:
a. a first light-emitting layer provided over the anode and containing a first host material and a first light-emitting material, wherein the first host material is a mixture of one or more mono-anthracene derivatives and one or more aromatic amine derivatives, wherein the mono-anthracene derivative(s) being provided in a volume fraction range of greater than 50% and less than or equal to 95% relative to the total layer volume, and the aromatic amine derivative(s) being provided in a volume fraction range of 1% to 40% relative to the total layer volume, and wherein the first light-emitting material has a peak emission in the yellow to red portion of the spectrum;
b. a second light-emitting layer provided over or under the first light-emitting layer, wherein the second light-emitting layer has a peak emission in the blue to cyan portion of the spectrum; and
c. wherein the peak emissions of the first and second light-emitting layers are selected such that together white light is produced by the OLED device.

2. The white light-emitting OLED device of claim 1 wherein the monoanthracene is a 9,10-diarylanthracene.

3. The white light-emitting OLED device of claim 2 wherein the monoanthracene is 9-(1-naphthyl)-10-(2-naphthyl)anthracene.

4. The white light-emitting OLED device of claim 1 wherein the second light-emitting layer contains an anthracene host.

5. The white light-emitting OLED device of claim 4 wherein the second light-emitting layer does not contain an aromatic amine derivative.

6. The white light-emitting OLED device of claim 5 wherein the second light-emitting layer contains an aminostyrylarene dopant.

7. The white light-emitting OLED device of claim 6 wherein the concentration of aminostyrylarene dopant in the second light-emitting layer is between 0.5% and 10%.

8. The white light-emitting OLED of claim 4 wherein the second light-emitting layer further includes an aromatic amine derivative co-host.

9. The white light-emitting OLED of claim 8 wherein the second light-emitting layer contains a bis(azinyl)azene borane complex dopant.

10. The white light-emitting dopant of claim 9 wherein the concentration of bis(azinyl)azene borane complex dopant is between 0.1% and 5%.

11. The white light-emitting OLED device of claim 1 wherein the first light-emitting layer is closer to the anode than the second light-emitting layer.

12. The white light-emitting OLED device of claim 1 wherein the first light-emitting layer emits yellow light and further including a non-emitting spacer layer between the first and second light-emitting layers.

13. A white light-emitting OLED device having an anode and a cathode, comprising:
a. a first light-emitting layer provided over the anode and containing a first host material and a first light-emitting material, wherein the first host material is a mixture of one or more mono-anthracene derivatives and one or more aromatic amine derivatives, wherein the mono-anthracene derivative(s) being provided in a volume fraction range of greater than 50% and less than or equal to 95% relative to the total layer volume, and the aromatic amine derivative(s) being provided in a volume fraction range of 1% to 40% relative to the total layer volume, and wherein the first light-emitting material has a peak emission in the green to red portion of the spectrum;
b. a second light-emitting layer provided over or under the first light-emitting layer, wherein the second light-emitting layer has a peak emission in the blue to cyan portion of the spectrum;
c. a third light-emitting layer provided closer to the anode than the first and second light-emitting layers; and
d. wherein the peak emissions of the first, second, and third light-emitting layers are selected such that together white light is produced by the OLED device.

14. The white light-emitting OLED device of claim 13 wherein the monoanthracene is a 9,10-diarylanthracene.

15. The white light-emitting OLED device of claim 14 wherein the monoanthracene is 9-(1-naphthyl)-10-(2-naphthyl)anthracene.

16. The white light-emitting OLED device of claim 13 wherein the second light-emitting layer contains an anthracene host.

17. The white light-emitting OLED device of claim 16 wherein the second light-emitting layer does not contain an aromatic amine derivative.

18. The white light-emitting OLED device of claim 17 wherein the second light-emitting layer contains an aminostyrylarene dopant.

19. The white light-emitting OLED device of claim 18 wherein the concentration of aminostyrylarene dopant in the second light-emitting layer is between 0.5% and 10%.

20. The white light-emitting OLED of claim 13 wherein the second light-emitting layer further includes an aromatic amine derivative co-host.

21. The white light-emitting OLED of claim 20 wherein the second light-emitting layer contains a bis(azinyl)azene borane complex dopant.

22. The white light-emitting dopant of claim 21 wherein the concentration of bis(azinyl)azene borane complex dopant is between 0.1% and 5%.

23. The white light-emitting OLED device of claim 13 wherein the first light-emitting layer is closer to the anode than the second light-emitting layer.

24. The white light-emitting OLED device of claim 23 wherein the third light emitting layer emits red light and the first light emitting layer emits green or yellow light.

25. The white light-emitting OLED device of claim 23 wherein the third light emitting layer emits yellow light and the first light emitting layer emits green light.
